(19) United States
(12) Patent Application Publication
(10) Pub. No.: US 2011/0275407 A1
(43) Pub. Date: Nov. 10, 2011

(54) MOBILE PHONE AND CONTROL METHOD THEREOF

(75) Inventor: LI-QUN XU, Nanjing (CN)

(73) Assignees: INVENTEC APPLIANCES (SHANGHAI) CO. LTD., Shanghai (CN); INVENTEC APPLIANCES CORP., NANJING, Nanjing (CN); INVENTEC APPLIANCES CORP., NEW TAIPEI CITY (TW)

(21) Appl. No.: 13/081,752

(22) Filed: Apr. 7, 2011

(30) Foreign Application Priority Data
May 6, 2010 (CN) 201010170185.2

(51) Int. Cl. H04M 1/00

(52) U.S. Cl. 455/552.1

(57) ABSTRACT

The present invention provides a mobile phone including: a casing; a first battery disposed inside the casing; a control module disposed inside the casing; and a signal converting module movably connected to the casing and including: a second battery; and a converting unit for converting at least one wireless signal into at least one 3rd-generation signal; wherein the converting unit is disabled by the control module when the signal converting module is connected to the casing; and the converting unit is enabled by the control module when the signal converting module is detached from the casing.

### BACKGROUND OF THE INVENTION

1. Field of the Invention

The present invention relates to a mobile phone and a control method thereof; and more particularly to a mobile phone concurrently having a wireless network function and a 3^{rd}-generation (3G) mobile communication function, and a mobile phone control method.

2. Brief Description of the Related Art

Through a network connection, information around the world can be accessed easily. Video conferencing, news searching, email receiving or sending, and data downloading can be done through the network easily. Hence, the network plays an indispensable role in the modern society.

To allow users to use the network outdoors, a wireless network technology has been developed. Users can surf the network by using a portable electronic device with a wireless network function capable of connecting to wireless network hotspots.

At present, a 3rd-generation (3G) mobile communication technology is developed, and wideband radio signals are used for transmitting network information. Users can connect to the network by using an electronic device with a 3G mobile communication function to connect to a wireless base station.

However, the density of the wireless network hotspots is very low; currently only some restaurants or transportation stations have wireless hotspots. Therefore, even if the users carry the portable electronic device with a wireless network feature with them, the location where they can connect to the network is still limited.

Further, the 3G mobile communication technology is not used extensively in various electronic devices yet, and the electronic device has to be used with a telephone number in order to use the 3G mobile communication function, but most electronic devices do not need the telephone number, and thus making it more difficult to promote the application of the 3G mobile communication technology.

Hence, the wireless network technology and the 3G mobile communication technology cannot provide a convenient wireless network environment due to the aforementioned reasons.

### SUMMARY OF THE INVENTION

The present invention relates to a mobile phone and a control method thereof, wherein a detachable signal converting module is used, such that any electronic device having a wireless network transmission function (even without the 3G mobile communication function) can connect to the network by the signal converting module through the 3G mobile communication technology, even in an area without a wireless network hotspot. The signal converting module can be detached from a casing of the mobile phone, and users can place the signal converting module among the electronic devices, and the mobile phone can still be portable and carried easily by the users.

To achieve the above object, the present invention provides a mobile phone comprising a casing, a first battery, a control module and a signal converting module. The first battery is installed in the casing. The control module is installed in the casing. The signal converting module is movably connected to the casing. The signal converting module comprises a second battery and a converting unit. The converting unit is used for converting at least one wireless signal into at least one 3rd-generation signal (3G mobile communication signal). Wherein, the converting unit will be disabled by the control module if the signal converting module is connected to the casing; and the converting unit will be enabled by the control module if the signal converting module is detached from the casing.

To achieve the above object, the present invention further provides a mobile phone control method applied to a mobile phone comprising a casing and a signal converting module; wherein the signal converting module is provided for converting at least one wireless signal to at least one 3rd-generation signal (3G mobile communication signal); and the mobile phone control method comprises the steps of: turning off the signal converting module when the signal converting module is connected to the casing; and turning on the signal converting module when the signal converting module is detached from the casing.

The technical contents of the present invention will become apparent by the detailed description of the preferred embodiments together with the illustration of related drawings as follows:

### BRIEF DESCRIPTION OF THE INVENTION

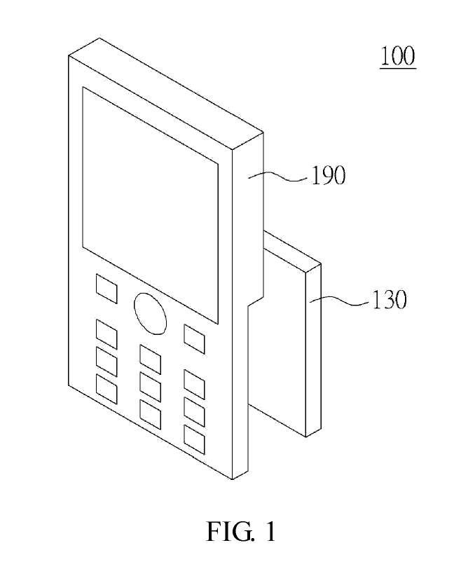

FIG. 1 is a schematic representation of the mobile phone according to the first embodiment of the present invention;

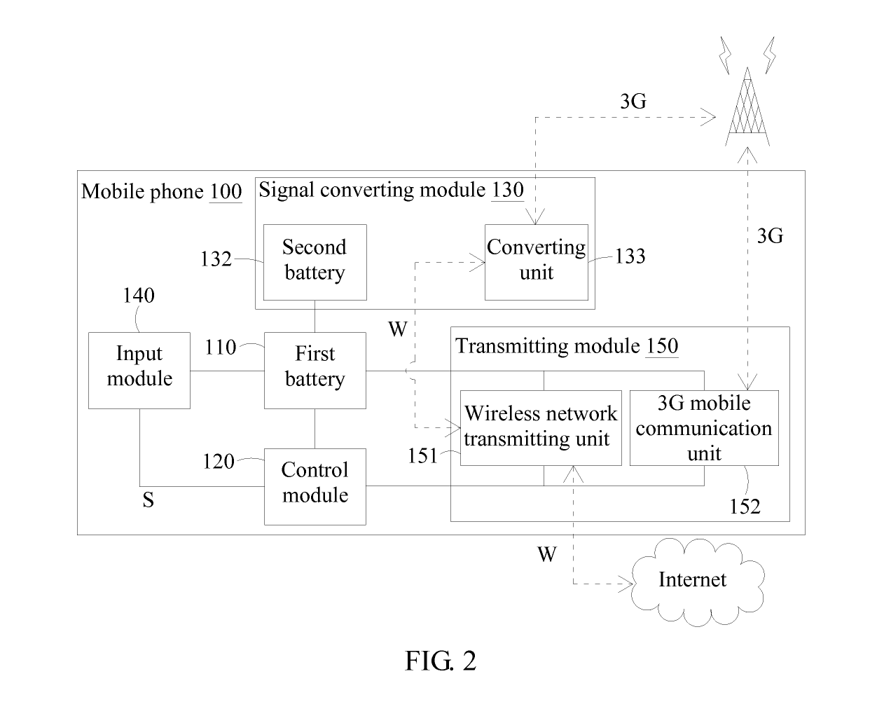

FIG. 2 is a block diagram of the mobile phone according to the first embodiment of the present invention;

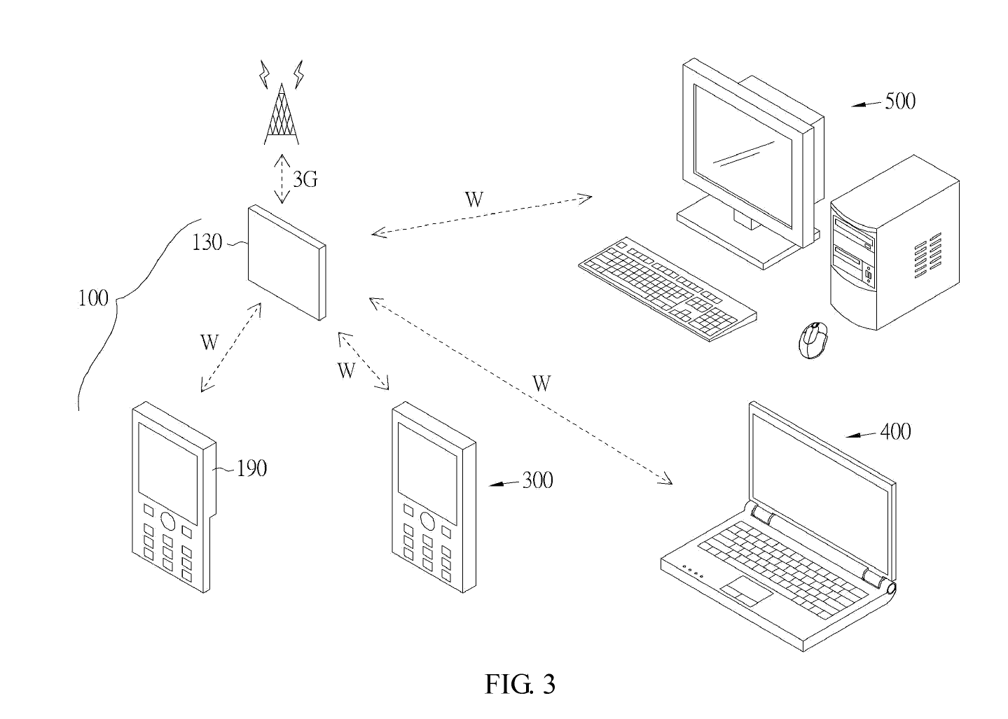

FIG. 3 is a schematic representation of the signal converting module being detached from the casing according to the present invention;

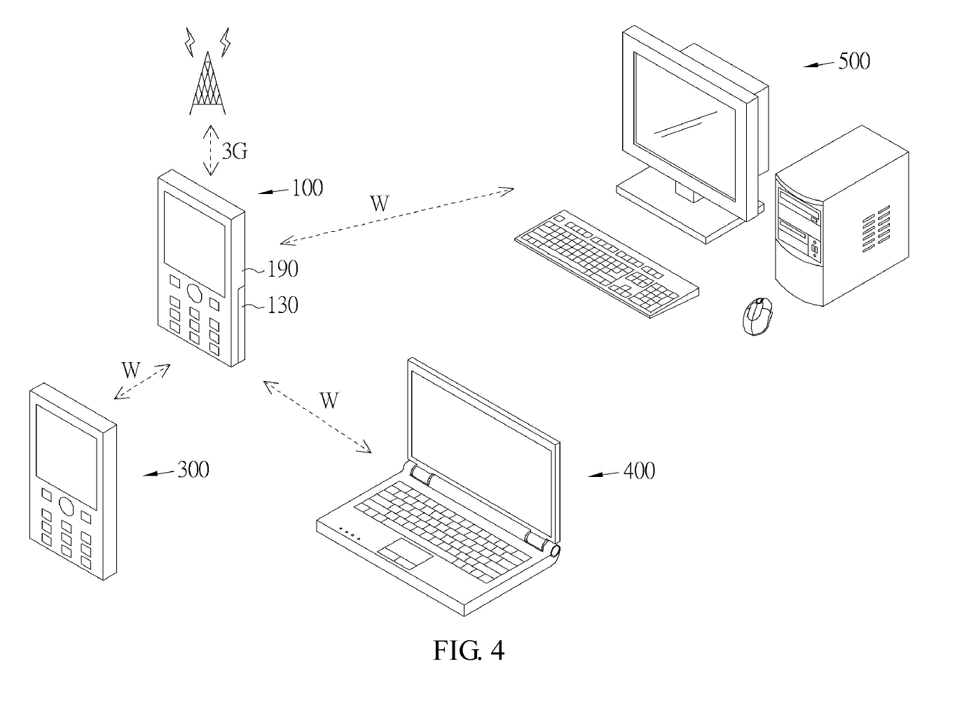

FIG. 4 is a schematic representation of the signal converting module being connected to the casing according to the present invention;

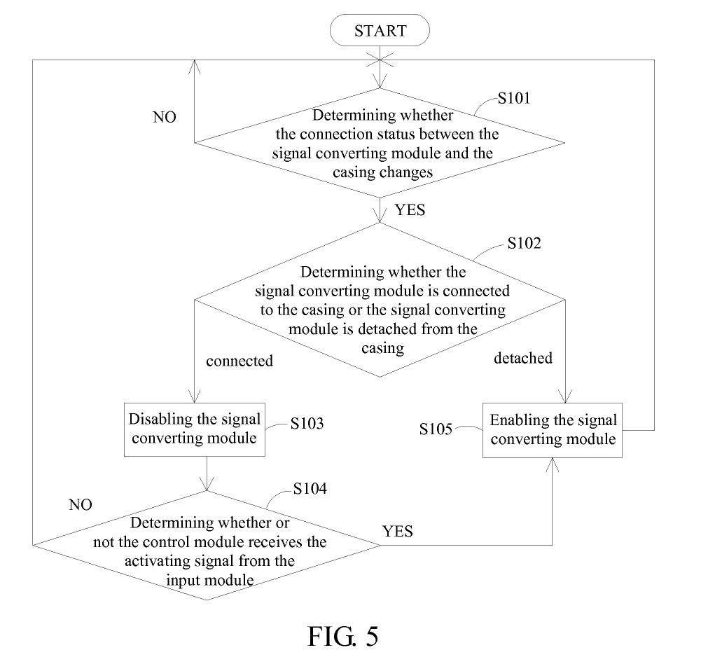

FIG. 5 is a flow chart illustrating the mobile phone control method according to the first embodiment of the present invention; and

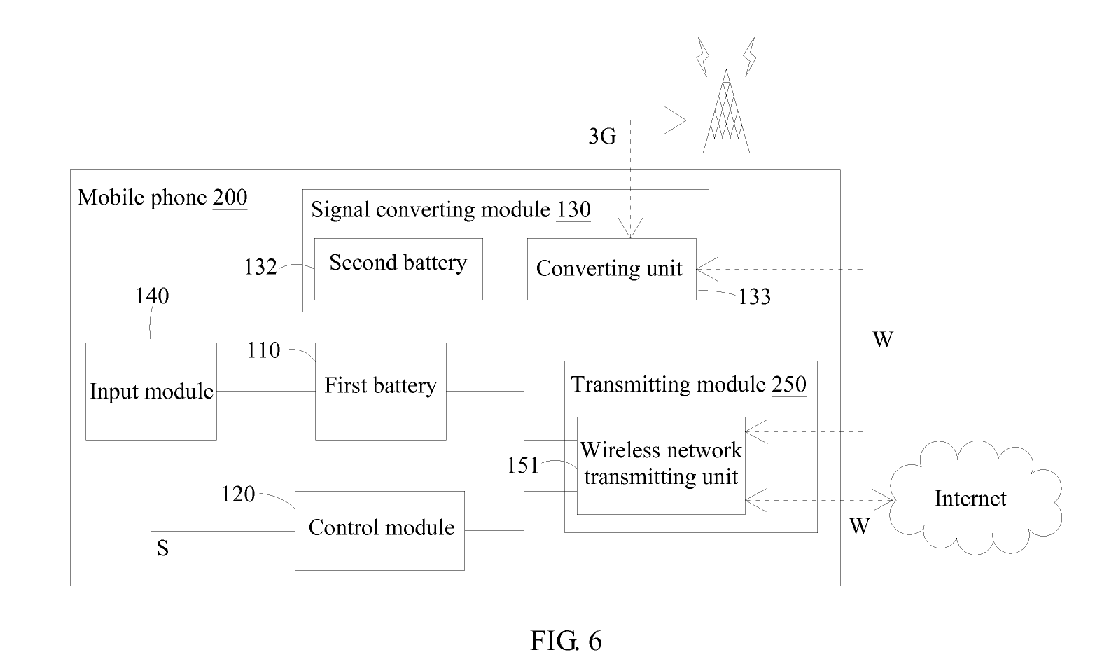

FIG. 6 is a block diagram of the mobile phone according to the second embodiment of the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### First Embodiment

With reference to FIGS. 1 and 2 for a schematic representation and a block diagram of a mobile phone 100 in accordance with a first preferred embodiment of the present invention respectively. The mobile phone 100 comprises a casing 190, a first battery 110, a control module 120, a signal converting module 130, an input module 140, and a transmitting module 150. The signal converting module 130 comprises a second battery 132 and a converting unit 133. The transmitting module 150 comprises a wireless network transmitting unit 151 and a 3G mobile communication unit 152. The first battery 110 and the second battery 132 are provided for storing electric power and supplying an operating voltage to the mobile phone 100, wherein the batteries 110 and 132 can be rechargeable batteries such as Ni—Cd batteries, Ni—Mh batteries, Li-lon batteries, Li-polymer batteries, or sealed batteries. The input module 140 is provided for inputting signals or data, wherein the input module 140 can be a touch panel, a keypad or a combination thereof. The transmitting module 150 is provided for transmitting different wireless signals, wherein the transmitting module 150 can be an antenna, a RF chip or a combination thereof. The control module 120 is provided for controlling the operation of different electronic components. The converting unit 133 is used for converting a wireless signal W into a 3G mobile communication signal 3G or converting a communication signal 3G into a wireless signal W. The control module 120 and the converting unit 133 can be semiconductor chips, firmware circuits, or computer readable storage media.

The signal converting module 130 is movably connected to the casing 190. The first battery 110, the control module 120, the input module 140 and the transmitting module 150 are all disposed inside the casing 190. The second battery 132 and the converting unit 133 are disposed inside the signal converting module 130.

Please further refer to FIGS. 2 and 3, wherein the FIG. 3 illustrates a schematic representation of the signal converting module 130 detached from the casing 190. The control module 120 enables the converting unit 133 when the signal converting module 130 is detached from the casing 190, such that the initial state of the converting unit 133 is “ON”. Now, the transmitting module 150 inside the casing 190 or other electronic devices (such as another mobile phone 300, a laptop computer 400 or a desktop computer 500) can transmit at least one wireless signal W to the signal converting module 130. And then the signal converting module 130 converts the wireless signal W to the communication signal 3G; for example, when an electronic device is uploading data, the wireless signal W is transmitted to the transmitting module 150 and converted to the communication signal 3G by the signal converting module 130; and then the communication signal 3G is transmitted to a 3G wireless base station (not shown in the figure).

When the electronic device is downloading data, the 3G base station receives the communication signal 3G, and the signal converting module 130 converts the communication signal 3G into the wireless signal W, and the transmitting module 150 transmits the wireless signal W to the electronic device, such that users can use the signal converting module 130 and the 3G mobile communication technology to connect to the network by any electronic device having a wireless network transmission function (even without the 3G mobile communication function) in an area without a wireless network hotspot.

Further, since the signal converting module 130 can be detached from the casing 190 of the mobile phone 100, the mobile phone 100 is still portable and carried easily by the users as long as the users can place the signal converting module 130 between the electronic devices and the mobile phone 100.

Wherein, when the signal converting module 130 is detached from the casing 190, the electric power of the signal converting module 130 is supplied by the second battery 132; and the electric power of the other electronic components inside the mobile phone 100 is supplied by the first battery 110. This allows the signal converting module 130 and the other electronic components inside the mobile phone 100 to operate normally when the signal converting module 130 is detached from the casing 190.

Please further refer to FIGS. 2 and 4, wherein the FIG. 4 is a schematic representation of the signal converting module 130 being connected to the casing 190. When the converting module 130 and the casing 19 are combined, the control module 120 disables the converting unit 133, such that the initial status of the converting unit 133 is “OFF”. This saves the power consumption of the signal converting module 130. Moreover, when the signal converting module 130 is connected to the casing 190, the first battery 110 and the second battery 132 are electrically connected, such that the second battery 132 can act as a second power source for the mobile phone 100. The second battery 132 can be charged through a travel charger of the mobile phone 100.

When the signal converting module 130 is connected to the casing 190, the user can use the input module 140 to issue an activating signal S to the control module 120. After that, the control module 120 enables the converting unit 132. Now, other electronic devices (such as another mobile phone 300, a laptop computer 400 or a desktop computer 500) can transmit a wireless signal W to the signal converting module 130. And then the signal converting module 130 converts the wireless signal W to the communication signal 3G This allows the user to connect to the network by any electronic device that has the wireless network function (even without the 3G mobile communication function). The electronic device can connect to the network through 3G mobile communication technology by a signal converting module 130.

Please further refer to FIGS. 2 and 5, wherein the FIG. 5 is a flow chart illustrating the control method for the mobile phone 100 according to the first embodiment of the present invention. In step S101, the control module 120 determines whether or not the connection status between the signal converting module 130 and the casing 190 changes. Perform step S102 when the connection status between the signal converting module 130 and the casing 190 changes; and return to step S101 when the connection status between the signal converting module 130 and the casing 190 does not change.

In step S102, the control module 120 determines whether the signal converting module 130 is connected to the casing 190 or the signal converting module 130 is detached from the casing 190. Perform Step S103 when the signal converting module 130 is connected to the casing 190; and perform Step S 105 when the signal converting module 130 is detached from the casing 190.

In step S103, the control module 120 disables the signal converting module 130 to avoid further power consumption of the converting unit 133.

After the step S103, perform Step S104. In Step S104, the control module 120 determines whether or not the control module 120 receives the activating signal S from the input module 140. Perform Step S 105 when the control module 120 receives the activating signal S from the input module 140; and return to Step S 101 when the control module 120 receives no activating signal S from the input module 140.

In Step S105, the control module 120 enables the signal converting module 130. Return to step S 101 after Step S105 takes place.

By the foregoing steps, the signal converting module 130 of the mobile phone 100 can be enabled immediately when the signal converting module 130 is detached from the casing 190 and the signal converting module 130 of the mobile phone 100 cab be disabled immediately when the signal converting module 130 is connected to the casing 190. This allows the signal converting module 130 being switched between enabled status and disabled status, without requiring a complicated setting.

### The Second Embodiment

Please refer to FIG. 6 for the block diagram of a mobile phone 200 according to the second embodiment of the present invention. The difference between the mobile phone 200 of this preferred embodiment and the mobile phone 100 of the first embodiment is that the transmitting module 250 comprises only the wireless network transmitting unit 151, and does not include a 3G mobile communication unit. When the user wants to transmit a communication signal 3G, the wireless signal W is transmitted to the signal converting module 130 first and then converted into the communication signal 3G to be transmitted to the outside.

In the mobile phone and the control method thereof disclosed in the foregoing embodiments of the present invention, the detachable signal converting module is used to allow the signal converting module being detached from the mobile phone and placed between electronic devices to act as a wireless network transceiver apparatus. Although the application of 3G mobile communication function is limited, the electronic device without 3G mobile communication function still can use the detachable signal converting module to connect to the network in an area without a wireless network hotspot.

While the invention has been described with reference to a preferred embodiment thereof, it is to be understood that modifications or variations may be easily made without departing from the spirit of this invention, which is defined in the appended claims.

What is claimed is:

1. A mobile phone comprising:
a casing;
a first battery disposed inside the casing;
a control module disposed inside the casing; and
a signal converting module movably connected to the casing and comprising:
a second battery; and
a converting unit for converting at least one wireless signal into at least one 3rd-generation signal (3G signal);
wherein the converting unit is disabled by the control module when the signal converting module is connected to the casing; and the converting unit is enabled by the control module when the signal converting module is detached from the casing.

2. The mobile phone as defined in claim 1, further comprising an input module for inputting an activating signal, wherein the control module enables the converting unit according to the activating signal.

3. The mobile phone as defined in claim 1, further comprising a transmitting module disposed inside the casing, wherein the wireless signal is transmitted to the signal converting module by the transmitting module.

4. The mobile phone as defined in claim 1, wherein the wireless signal is transmitted to the signal converting module from another electronic device.

5. The mobile phone as defined in claim 1, wherein the first battery and the second battery are electronically connected when the signal converting module is connected to the casing.

6. The mobile phone as defined in claim 1, wherein the signal converting module converts a plurality of the wireless signals into a plurality of the 3rd-generation signals (3G signals).

7. A mobile phone control method, suited for a mobile phone comprising a casing and a signal converting module; wherein the signal converting module converts at least one wireless signal to at least one 3rd-generation signal (3G signal); and the mobile phone control method comprises the steps of:
disabling the signal converting module when the signal converting module is connected to the casing; and
enabling the signal converting module when the signal converting module is detached from the casing.

8. The mobile phone control method as defined in claim 7, further comprising the step of enabling the signal converting module when an activating signal is received.

9. The mobile phone control method as defined in claim 7, wherein the mobile phone further comprises a transmitting module disposed inside the casing; and the mobile phone control method further comprises:
transmitting the wireless signal to the signal converting module by the transmitting module.

10. The mobile phone control method as defined in claim 7, wherein the wireless signal is transmitted to the signal converting module from another electronic device.

11. The mobile phone control method as defined in claim 7, wherein the mobile phone further comprises a first battery disposed inside the casing; the signal converting module further comprises a second battery; and the mobile phone control method further comprises the step of electronically connecting the first battery and the second battery when the signal converting module is connected to the casing.

12. The mobile phone control method as defined in claim 7, wherein the signal converting module converts a plurality of the wireless signals into a plurality of the 3rd-generation signals (3G signals).
